(19) United States
(12) Patent Application Publication
(10) Pub. No.: US 2020/0192121 A1
(43) Pub. Date: Jun. 18, 2020

(54) CONTACT LENS FOR PRESBYOPIA WITH PINHOLE RING

(71) Applicant: Anderledge Vision LLC, Omaha, NE (US)

(72) Inventor: Tiffany Gay Anderson, Omaha, NE (US)

(21) Appl. No.: 16/716,713

(22) Filed: Dec. 17, 2019

Related U.S. Application Data
(60) Provisional application No. 62/780,583, filed on Dec. 17, 2018.

(51) Int. Cl. G02C 7/04; G02C 7/16

(52) U.S. Cl. CPC G02C 7/049; G02C 7/047; G02C 7/044; G02C 7/16

(57) ABSTRACT

A contact lens comprising an optically transparent lens body having a concave surface adapted to the patient's eye curvature and a convex surface. The contact lens comprises a light transmitting region and a light blocking region. The light blocking region comprises a plurality of fine holes that are evenly spaced throughout the light blocking region.

### CROSS REFERENCE TO RELATED APPLICATION

This application claims priority to U.S. Provisional Application Ser. No. 62/730,714 filed on Sep. 13, 2018, and U.S. Provisional Application Ser. No. 62/780,583 filed on Dec. 17, 2018, both of which are hereby incorporated by reference in their entireties.

### FIELD OF THE INVENTION

The present disclosure relates to a contact lens for presbyopia designed to correspond to different corneal topographic patterns of individual users by adjusting a light transmitting region of the contact lens according to a corneal topographic pattern of each user.

### BACKGROUND

Contact lenses are widely used for different types of vision deficiencies and proven safe. These include defects such as near-sightedness and far-sightedness (myopia and hypermetropia, respectively), and defects in near range vision usually associated with aging (presbyopia). Presbyopia occurs as a person ages when the lens of the eye begins to stiffen.

Corneal inlays are also utilized for vision corrections. Corneal inlays are often small lenses inserted into the cornea through surgery. Example, KAMRA inlays are used to improve near vision and to reduce the need for reading glasses in older adults who have presbyopia. The inlay is placed within the cornea under a LASIK-style flap (laser assisted in situ keratomileusis). Patients who had the inlay implanted in the cornea of their non-dominant eye can realize an improvement of five lines of near visual acuity and an improvement of one to two lines of intermediate visual acuity on a standard eye chart, while maintaining binocular distance vision of 20/20. KAMRA methods is a pinhole ring (black or colored) in the cornea of presbyopic eyes to enhance the depth of field, thereby providing improved presbyopic performance without the need for glasses or contact lenses. An intrastromal ring is created with a femtosecond laser, and at least one side port is created with the laser in the periphery of the ring (or radially to the ring). Dye is injected in the cornea via the side port(s) to create a pigmented ring in the stroma. The pigmented ring treats presbyopia by blocking unfocused light and allowing focused light to reach the retina. Image sharpness increases as the effective size of the pupil decreases. This procedure has had positive clinical trials and is Food and Drug Administration (FDA) approved.

### BRIEF DESCRIPTION OF THE FIGURES

FIG. 1 is a diagram showing an example where a contact lens for presbyopia is put on an eyeball.

FIG. 2 is a detailed view illustrating a structure of a contact lens for presbyopia.

### SUMMARY

One aspect of the present disclosure is directed to a contact lens. The contact lens comprises a light transmitting region which is spaced apart from a central portion of the contact lens by a preset distance of from about 0.5 mm to about 1.25 mm, and configured to transmit incident light; and a light blocking region provided outside of the light transmitting region and having a size greater than the light transmitting region and smaller than the contact lens, configured to block the incident light, and comprising a plurality of fine holes uniformly spaced throughout the light blocking region. In one aspect, the contact lens is a gas permeable contact lens (also referred to as gas permeable lens). In another aspect, the contact lens is a soft contact lens. Yet other types of contact lens to be used as part of the present disclosure are disclosed herein.

Other aspects and features of the present disclosure will be in part apparent and in part pointed out hereinafter.

### DETAILED DESCRIPTION

Provided herein is a contact lens for presbyopia that is designed to correspond to different corneal topographic patterns of individual users by adjusting a light transmitting region of the contact lens according to a corneal topographic pattern of each user.

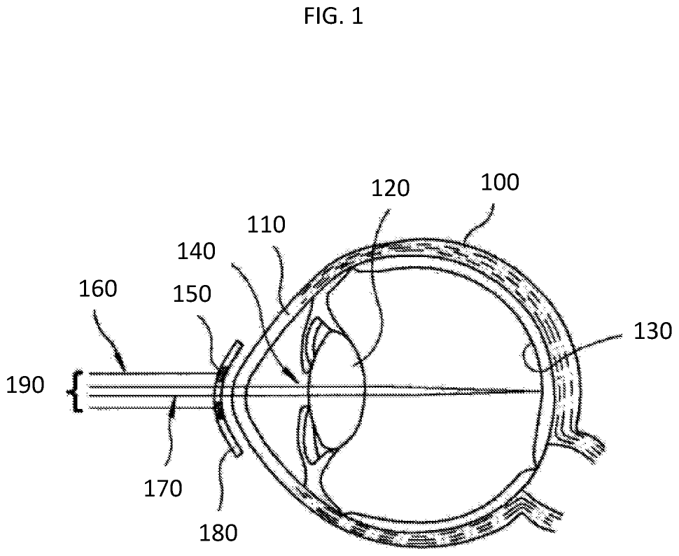

FIG. 1 depicts a diagram where a contact lens of the present disclosure is put on the eyeball. While described herein as a soft contact lens, it should be understood that any lens in the contact lens art can be used without departing from the scope of the present disclosure. Suitable other types of contact lens include silicone hydrogel contact lens, gas permeable contact lens, scleral contact lens, poly (methyl methacrylate) (PMMA) or “hard” contact lens, and hybrid contact lens.

A depicted in FIG. 1, a human eye 100 includes a cornea 110; an eye lens 120, located at a rear surface of the cornea 110 within the eyeball; and other structures not identified herein. The cornea 110 is a first focus forming element, and the eye lens 120 is a second focus forming element. The human eye 100 also includes a retina 130 which is in contact with the inside of a rear surface of the eye 100. The retina 130 includes receptor cells and a high-sensitivity region known as a macula. Signals are received at the retina and transmitted to the visual center of the brain through optic nerves.

In the human eye 100, incident light 190 upon the cornea 110 is focused on a surface of the retina 130 after refracted through the eye lens 120, thus allowing a person to recognize an object. If, however, the eye lens 120 is not smoothly contacted as a result of presbyopia or the like, a part of the light 190 that has reached the retina 110 through various paths may not exactly focus on the surface of the retina 130, resulting in a presbyopic phenomenon such as blurred vision on the object, as mentioned earlier.

The present disclosure provides a contact lens 180 comprising a light blocking region 150 capable of blocking the light 190 selectively to thereby adjust the amount of the light 190 that arrives at the retina 110 and is projected on the cornea 110. If this contact lens 180 is put on, the light 190 that arrives at the eye lens 120 through the cornea 110 can be selectively blocked, as depicted in FIG. 1. Accordingly, rays 190 and 160 that are incident upon the retina 130 through out-of-focusing paths can be blocked, so that the depth of a focus can be heightened.

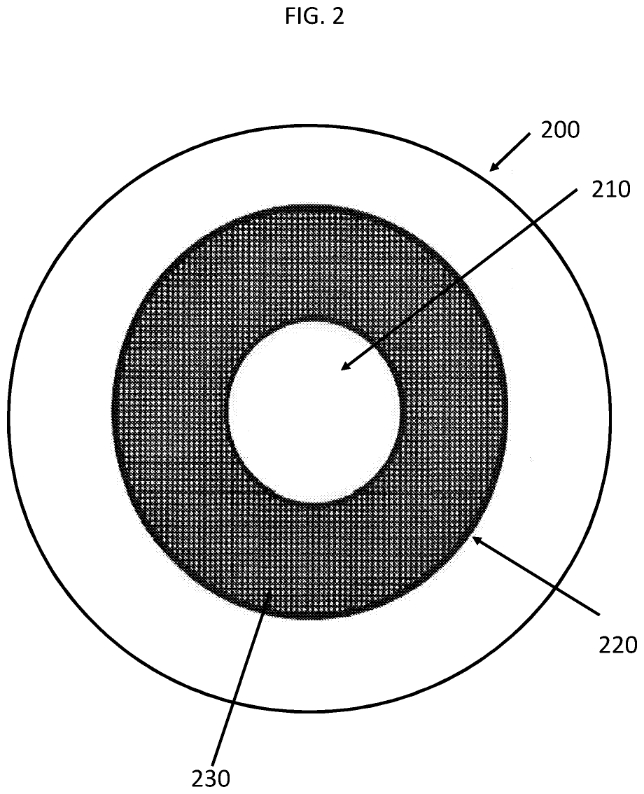

Although the vision may be darkened due to the blocking of the rays 160 for the purpose of increasing the depth of the focus, such a problem can be solved by forming, at the light blocking region 150, a plurality of fine holes (not shown) for allowing light to pass therethrough. A more detailed mechanism of the contact lens 180 will be discussed below with reference to FIG. 2 which shows a structure of the contact lens 180.

The contact lens 200 includes a light transmitting region 210; a light blocking region 220; and a plurality of fine holes 230 within the light blocking region.

The light transmitting region 210 is formed at a central portion of the contact lens 200 in a preset size and transmits incident light. The light transmitting region 210 serves to reduce an eyeball size, thus reducing the light 190 incident upon the retina 130 from different directions while allowing the light to reach the retina only in consistent directions, resulting in an increase of the depth of the focus for the light 190 to focus on the retina 130.

The light 190 incident upon the eye lens 120 at various positions forms images of an object at various positions on the retina 130. Thus, if an incident angle of the light 190 is reduced by providing the light transmitting region 210, a path through which the light 190 enters is narrowed. As a result, the amount of the incident light 190 is reduced, and, thus, a part of the various images formed at the various positions may disappear, resulting in an increase of the depth of the focus. At this time, the light passing through the same path forms a clear image constantly regardless of a distance of the light.

Meanwhile, in general, the depth of the focus may increase with a decrease of the size of the light transmitting region 210. If, however, the light transmitting region 210 is too small, it may not be suitable for the eyeball usually having a size in the range from about 2 mm to about 4 mm. Also, if the size of the light transmitting region 210 is too small, a doughnut shape may be seen when the eyeball expands due to light reflection in the environment where the light is weak. Meanwhile, if the light transmitting region 210 is too large, the pinhole effect would be declined, making it impossible to adjust the depth of the focus.

Though the light transmitting region 210 is described to have the circular shape for the convenience of explanation, the shape of the light transmitting region 210 may be modified in various ways and may be a circle, an oval, a rectangle, or a rhombus.

In an embodiment, the diameter of the light transmitting region 210 may be from about 1.0 mm to about 2.5 mm. In some embodiments, the diameter of the light transmitting region 210 may be about 1.0 mm, about 1.1 mm, about 1.2 mm, about 1.3 mm, about 1.4 mm, about 1.5 mm, about 1.6 mm, about 1.7 mm, about 1.8 mm, about 1.9 mm, about 2.0 mm, about 2.1 mm, about 2.2 mm, about 2.3 mm, about 2.4 mm, or about 2.5 mm. In a further embodiment, the diameter of the light transmitting region 210 may be about 1.6 mm.

In an embodiment, the light transmitting region 210 which is spaced apart from a central portion of the contact lens 200 by a preset distance of from about 0.5 mm to about 1.25 mm. In some embodiments, the transmitting region 210 which is spaced apart from a central portion of the contact lens by a preset distance of about 0.5 mm, about 0.75 mm, about 1 mm, or about 1.25 mm.

In an embodiment, the light transmitting region 210 is formed into a circle having a diameter greater than zero and less than the diameter of the contact lens 200.

The light blocking region 220 is formed at an outside of the light transmitting region 210, having a size greater than the light transmitting region 210 and smaller than the contact lens 200. This light blocking region 220 blocks some of the light 190 that attempts to reach the retina 110. At this time, the light blocking region 220 may be formed to have a diameter greater than that of the light transmitting region 210 and smaller than that of the contact lens 200.

As stated above, due to the light blocking function of the light blocking region 220, only the rays 170 of the incident light 190 passing through the light transmitting region 210 are transmitted, so that the depth of the focus can be improved.

If, however, the light is completely blocked by the light blocking region 220, the amount of the light 190 incident upon the eye 100 may be reduced, and the vision would be darkened and a doughnut shape conforming to the light blocking region 220 would appear into sight.

In view of this problem, by forming a plurality of fine holes 230 (for example, the plurality of fine holes can be formed within portions of the light blocking region (220) which are not tinted or colored), which are capable of allowing the light 190 to pass therethrough, at the light blocking region 220, as shown in FIG. 2, the amount of the incident light 190 can be additionally obtained to some extent, and, thus, the doughnut shape phenomenon can be reduced and bright vision can be achieved. In an embodiment, the plurality of fine holes 230 may be distributed within the light blocking region 220 in a non-uniform manner. In an alternative embodiment, the plurality of fine holes 230 may be distributed within the light blocking region 220 in a uniform manner.

The smaller the gap between the fines holes 230 is, the more sufficient light can be obtained, whereas the greater the gap is, the better the contrast would be. The gap between the fine holes can be determined by one skilled in the art based upon the desired amount of contrast and the number of fine holes within the light blocking region 220.

In an embodiment, the diameter of each fine hole 230 may independently be from about 0.10 mm to about 0.20 mm. In some embodiments, the diameter of each fine hole 230 may independently be about 0.1 mm, about 0.11 mm, about 0.12 mm, about 0.13 mm, about 0.14 mm, about 0.15 mm, about 0.16 mm, about 0.17 mm, about 0.18 mm, about 0.19 mm, or about 0.20 mm.

In an embodiment, the diameter of the light blocking region 220 may be from about 1.0 mm to about 4.5 mm. In some embodiments, the diameter of the light blocking region 220 may be about 1.0 mm, about 1.1 mm, about 1.2 mm, about 1.3 mm, about 1.4 mm. about 1.5 mm, about 1.6 mm, about 1.7 mm, about 1.8 mm, about 1.9 mm, about 2.0 mm, about 2.1 mm, about 2.2. mm, about 2.3 mm, about 2.4 min, about 2.5 mm, about 2.6 mm, about 2.7 mm, about 2.8 mm, about 2.9 mm, about 3.0 mm, about 3.1 mm, about 3.2 mm, about 3.3 mm, about 3.4 mm, about 3.5 mm, about 3.6 mm, about 3.7 mm, about 3.8 mm, about 3.9 mm, about 4.0 mm, about 4.1 mm, about 4.2 mm, about 4.3 mm, about 4.4 mm, or about 4.5 mm. In a further embodiment, the diameter of the light blocking region 220 may be about 3.8 mm. The diameter of the light blocking region 220 includes the diameter of the light transmitting region 210.

In an embodiment, the light blocking region 220 is formed to be concentric with the light transmitting region 210 and formed into a shape having a diameter greater than the diameter of the light transmitting region 210 and smaller than the diameter of the contact lens 200.

The number of fine holes 230 within the light blocking region 220 will determine the “opacity” of the light blocking region 220. The “opacity” of the light blocking region 220 may be between about 1 and 100%. In some embodiments, the “opacity” of the light blocking region 220 may be between about 1 and 100%, about 10 and 90%, or about 20 and 80%. The number of fine holes 230 in the light blocking region 220 is inversely proportional to the “opacity.” Thus, as the number of fine holes 230 in the light blocking region 220, the “opacity” decreases.

In an embodiment, the “opacity” of the light blocking region 220 may be between about 1% and 100%. In some embodiments, the “opacity” of the light blocking region 220 may be about 1%, about 5%, about 10%, about 15%, about 20%, about 25%, about 30%, about 35%, about 40%, about 45%, about 50%, about 55%, about 60%, about 65%, about 70%, about 75%, about 80%, about 85%, about 90%, about 95%, or 100%.

The light transmitting region 210 may have a zero, positive, or negative optical power. In an embodiment, the light transmitting region 210 may have a different optical power than the plurality of fine holes 230 within the light blocking region 220. In an alternative embodiment, the light transmitting region 210 may have the same optical power as the plurality of fine holes 230 within the light blocking region 220.

In an embodiment, the light transmitting region 210 may have an optical power that is within the range of a contact lens. Such an optical power could be determined by one of skill in the art. In some embodiments, the light transmitting region 210 may have an optical power of, for example, about −5.0, about −4.5, about −4.0, about −3.5, about −3.0, about −2.5, about −2.0, about −1.5, about −1.0, about −0.5, about 0, about +0.5, about +1.0, about +1.5, about +2.0, about +2.5, about +3.0, about +3.5, about +4.0, about +4.5, or about +5.0.

In an embodiment, the plurality of fine holes 230 within the light blocking region 220 may have an optical power that is within the range of a contact lens. Such an optical power could be determined by one of skill in the art. In some embodiments, the plurality of fine holes 230 within the light blocking region 220 may have an optical power of, for example, about −5.0, about −4.5, about −4.0, about −3.5, about −3.0, about −2.5, about −2.0, about −1.5, about −1.0, about −0.5, about 0, about +0.5, about +1.0, about +1.5, about +2.0, about +2.5, about +3.0, about +3.5, about +4.0, about +4.5, or about +5.0.

The contact lens 200 may be made from materials suitable for the particle type of contact lens. For soft contact lens such as shown, such materials include, without limit, low water nonionic polymers, high water nonionic polymers, low water ionic polymers, high water ionic polymers, and silicon hydrogel polymers. Suitable low water nonionic polymers, without limit, teflicon, tetrafilcon A, crofilcon, hefilcon A, hefilcon B, mafilcom, polymacron, hioxiflcon B, galyfilcon A, lotrafilcon A, lotrafilcon B, senofilcon A, and senoflicon B. Suitable high water nonionic polymers include, without limit, surflicon A, lidofilcon A, lidofilcon B, netrafilcon A, hefilcon C, alfafilcon A, omafilcon A, vasurfilcon A, hioxifilcon A, hioxifilcon D, nelfilcon, hilafilcon A, hilafilcon B, and nesofilcon A. Suitable low water ionic polymers include, without limit, balafilcon A, bufilcon A, deltafilcon A, and phemfilcon. Suitable high water ionic polymers include, without limit, bufilcon A, perfilcon A, etafilcon A, focofilcon A, ocufilcon B, ocufilcon C, ocufilcon D, ocufilcon E, ocufilcon F, phemfilcon A, methafilcon A, methafilcon B, and vilfilcon A. Suitable silicon hydrogel polymers include, without limit, delefilcon A, narafilcon B, narafilcon A, and stenfilcon A.

If the contact lens is a gas permeable lens, suitable materials including fluorosilicone acrylate, fluoro-siloxane acrylate, silicone acrylate, and the like, and combinations thereof.

For hybrid contact lens, a central optical zone is suitably made of a gas permeable lens material as described above, surrounded by a peripheral fitting zone made of silicone hydrogel or regular hydrogel soft contact lens material as described above.

In an embodiment, the diameter of the contact lens 200 may be from about 8 mm to about 14 mm. In some embodiments, the diameter of the contact lens 200 may be about 8 mm, about 8.5 mm, about 9 mm, about 9.5 mm, about 10 mm, about 10.5 mm, about 11 mm, about 11.5 mm, about 12 mm, about 12.5 mm, about 13 mm, about 13.5 mm, or about 14 mm.

In certain embodiments, the contact lens 200 may be a color lens that is tinted or colored with a certain color. Suitable colors include, without limit, white, yellow, red, orange, purple, blue, green, and black. The contact lens may be any shade or combination of the aforementioned colors.

Those of skill in the art should, in light of the present disclosure, appreciate that many changes can be made in the specific embodiments which are disclosed and still obtain a like or similar result without departing from the spirit and scope of the invention.

What is claimed is:

1. A contact lens, comprising:
a light transmitting region which is spaced apart from a central portion of the contact lens by a preset distance of from about 0.5 mm to about 1.25 mm, and configured to transmit incident light; and
a light blocking region provided outside of the light transmitting region and having a size greater than the light transmitting region and smaller than the contact lens, configured to block the incident light, and comprising a plurality of fine holes uniformly spaced throughout the light blocking region.

2. The contact lens of claim 1, wherein the plurality of fine holes in the light blocking region allow the incident light to pass therethrough.

3. The contact lens of claim 1, wherein the plurality of fine holes has a zero, positive, or negative optical power.

4. The contact lens of claim 1, wherein the light transmitting region is formed into a circle, an oval, a rectangle, or a rhombus.

5. The contact lens of claim 1, wherein the light transmitting region is formed into a circle having a diameter greater than zero and less than the diameter of the contact lens.

6. The contact lens of claim 1, wherein the light blocking region is formed to be concentric with the light transmitting region and formed into a shape having a diameter greater than the diameter of the light transmitting region and smaller than the diameter of the contact lens.

7. The contact lens of claim 1, wherein the light blocking region is formed into a circle, an oval, a rectangle, or a rhombus.

8. The contact lens of claim 1, wherein the light transmitting region has a zero, positive, or negative optical power.

9. The contact lens of claim 1, wherein the diameter of the light transmitting region is from about 1.0 mm to about 2.5 mm.

10. The contact lens of claim 1, wherein the diameter of the light blocking region is from about 1.0 mm to about 4.5 mm.

11. The contact lens of claim 1, wherein the contact lens is a color lens tinted with a certain color.

12. The contact lens of claim 1, wherein the diameter of the contact lens is from about 8 mm to about 14 mm.

13. The contact lens of claim 1 being selected from the group consisting of soft contact lens, silicone hydrogel contact lens, gas permeable contact lens, scleral contact lens, poly (methyl methacrylate) (PMMA) or “hard” contact lens, and hybrid contact lens.
